(19) United States
(12) Patent Application Publication
(10) Pub. No.: US 2009/0187451 A1
(43) Pub. Date: Jul. 23, 2009

(54) METHOD, COMPUTER AND PROGRAM FOR ASSIGNING SEAT TO PERSON

(75) Inventor: Toshiyuki Omiya, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: P&W SOLUTIONS CO., LTD., Tokyo (JP)

(21) Appl. No.: 12/306,206

(22) PCT Filed: Jun. 26, 2007
(86) PCT No.: PCT/JP2007/062763

§ 371 Date: Dec. 22, 2008

(30) Foreign Application Priority Data
Jun. 29, 2006 (JP) 2006-179526

(51) Int. Cl. G06Q 10/00

(52) U.S. Cl. 705/8

(57) ABSTRACT

The present invention has the object of providing a method of managing changes of assignments in response to various disturbances that may occur up to the work date after creating an assignment plan. A computer 1 includes a memory 120 storing assignment data including at least data related to employees assigned and a period of use for each of the seats, reads the assignment data from the memory 120 and displays thereof on a display unit 150 according to an operation requesting display of the assignment data accompanying designations of a seat and a period, accepts a designating operation of a seat and an employee as targets of change and a seat after change, determines whether the seat after change accepted is usable, and changes the assignment data and stores thereof in the memory 120 in a case in which it is determined that the seat after change is usable.

### TECHNICAL FIELD

The present invention relates to a method, computer, and program for assigning employees to seats.

### BACKGROUND ART

In a call center that receives inquiry calls and the like from customers, or that makes sales calls and the like; or a contact center that introduces Internet technology, and carries out exchanges of e-mail, chat messages, and the like with customers (heretofore referred to as a “contact center”), placing of staff called operators or communicators (heretofore referred to as “communicators”) is an important factor affecting work efficiency and quality.

Typically, an experienced manager, called a “supervisor” (SV), manages between a few to a few dozen communicators, and further, there are times when the supervisor (SV) may assist those agents with less experience according to their experience or skills, and therefore, taking these circumstances into consideration, there is a need to perform an optimal assignment of seats.

Conventionally, in a case of performing an assignment of seats for communicators in a contact center, in order to reflect the above-described requirements, a method for automatically creating an assignment plan for seats upon accepting various requirements of work hours, occupational ability level, type of responsibility, and the like has been proposed (Patent Document 1).

[Patent Document 1] Japanese Unexamined Patent Application Publication No. 2003-157343

### DISCLOSURE OF THE INVENTION

### Problems to be Solved by the Invention

However, even according to the technology of Patent Document 1, after creating an assignment plan, when dealing with various disturbances that may occur up to a work date (failure of equipment, absence due to illness of employees, unexpected increases in received communication, and the like), it is not possible to carry out management of changes satisfying the above-described various assignment requirements while faithfully reflecting these disturbances.

Therefore, it is desirable, after creating an assignment plan, to provide a method of carrying out management of changes of assignments in response to various disturbances that may occur up to the work date.

Thus, the present invention has the object of providing a method of carrying out management of changes of assignments in response to various disturbances that may occur up to the work date after creating an assignment plan.

### Means for Solving the Problems

The present invention, for the purpose of the above-mentioned objective, more specifically provides the following:

In a first aspect, a method by which a computer (computer 1) assigns employees to seats, in which

the computer includes a memory (memory 120) for storing assignment data configured to include at least data related to employees assigned and a period of use for each of the seats, the method comprises steps of:

accepting operations requesting display of the assignment data, accompanying designations of a seat and a period, from a user of the computer,

reading the assignment data from the memory and displaying thereof on a display unit (display unit 150), according to an accepting of the operation requesting display,

accepting a designating operation of a seat and an employee as targets of change, and of a seat after change, from the user,

referring to assignment data stored in the memory, and determining whether the seat after change accepted is usable,

changing the assignment data and storing thereof in the memory, in a case in which it is determined that the seat after change is usable, and

displaying the assignment data after change on the display unit.

According to this configuration, an operational effect is achieved in which the computer includes a memory (memory 120) for storing assignment data configured to include at least data related to employees assigned and a period of use for each of the seats,

accepts an operation requesting display of the assignment data, accompanying designations of a seat and a period, from a user of the computer,

reads the assignment data from the memory and displays thereof on a display unit (display unit 150), according to an accepting of the operation requesting display,

accepts a designating operation of a seat and an employee as targets of change, and of a seat after change, from the user,

refers to assignment data stored in the memory, and determines whether the seat after change accepted is usable,

changes the assignment data and stores thereof in the memory, in a case in which it is determined that the seat after change is usable, and

displays the assignment data after change on the display unit.

As a result, it is possible for the computer, to display on the display unit data relating to an employee assigned to a seat and a period of use, which is included in assignment data stored in the memory, to determine whether a change of a seat is possible by accepting an operation from the user, and in a case of being possible, to display the assignment data after change on the display unit.

As a result, it is possible for the user to carry out suitable changes in seats in response to various disturbances that may occur up to the work date after drawing up an employee assignment plan, and to carry out suitable management of changes of assignment.

In a second aspect, the method described in the first aspect further comprises a step of displaying on the display unit that the change is not possible, without carrying out change of the assignment data, in a case of determining that the seat after change is not usable.

According to this configuration, an operational effect is achieved in which the computer displays on the display unit that the change is not possible, without carrying out change of the assignment data, in a case of determining that the seat after change is not usable.

As a result, it is possible for the computer, in a case in which changing a seat is impossible, to display a message or the like to that effect on the display unit, thus informing a user.

Therefore, it is possible for the user, by merely repeatedly carrying out an operation of designating a seat desired to be changed, to realize a seat change while avoiding with certainty seats that cannot be changed, and avoid a risk of changing to assignment data that cannot be realized by an operational error or the like.

In a third aspect, the method described in the first aspect or the second aspect, in which the memory further stores data representing whether equipment at the seat is out of order, further comprises steps of:

accepting a designating operation of the seat for which a failure has occurred from the user in a case in which failure of equipment at the seat has occurred,

storing in the memory status data indicating that equipment at the seat designated is out of order, according to an accepting of the designating operation, and

displaying on the display unit that equipment at the seat is out of order, based on status data stored in the memory.

According to this configuration, an operational effect is achieved in which the memory unit further stores data representing whether equipment at the seat is out of order, and

the computer accepts a designating operation of the seat for which a failure has occurred from the user in a case in which failure of equipment at the seat has occurred,

stores in the memory status data indicating that equipment at the seat designated is out of order, according to an accepting of the designating operation, and

displays on the display unit that equipment at the seat is out of order, based on status data stored in the memory.

According to this, it is possible for the computer to store in the memory, by accepting an operation of the user, status data of a seat at which a failure has occurred, and to display that on the display unit.

The result is that it is possible for the user sequentially to input information for seats for which a failure has occurred, for which moving employees is necessary, or for which newly assigning employees is not possible. Afterwards, when referring to the status data, it is possible for the user to confirm at a glance whether a failure has occurred.

According to a fourth aspect, in the method described in any one of the first to third aspects, in the step of reading the assignment data and displaying thereof on the display unit, the computer, in response to the seat designated and period, displays a calendar chart indicating a chronological state of use of each of the seats, and

in the calendar chart, displays a period for which the seat is in use distinctly from a period being available.

According to this configuration, an operational effect is achieved in which, in a step of reading the assignment data and displaying thereof on the display unit, the computer, in response to the seat designated and period, displays a calendar chart indicating a chronological state of use of each of the seats, and

in the calendar chart, displays a period for which the seat is in use distinctly from a period being available.

As a result, it is possible for the computer to display the calendar chart, and to display status of availability and the like of a seat during a designated period in an easy-to-read calendar chart format.

The result is that it is possible for the user, when moving seats of employees due to failure of equipment and the like, at a time of reviewing to which seat to be moved, to carry out review while referring to the calendar chart. Therefore, it is possible for the user, before carrying out a movement operation to a seat to which a new employee cannot be assigned because an employee has already been assigned, to be able to learn of that fact just by confirming the calendar chart, and to carry out with certainty a change operation for an available seat after confirmation through visual perception. Therefore, it is possible for the user to reduce labor required for a change operation for a seat.

According to a fifth aspect, in the method described in any one of the first to third aspects, in the step of reading the assignment data and displaying thereof on the display unit, the computer, in response to a period that at least includes a current time, displays a calendar chart indicating a chronological state of use of each of the seats designated.

According to this configuration, an operational effect is achieved in which, in the step of reading the assignment data and displaying thereof on the display unit, the computer, in response to a period that at least includes a current time, displays a calendar chart indicating a chronological state of use of each of the seats designated.

As a result, since the computer, in response to a period that at least includes a current time, can display a calendar chart of status of use for each of the seats designated, it is always possible to inform the user of a status of use closely following the passage of time.

The result is that it is possible for the user, who may be an on-site manager or the like, continually to watch a state of use of seats at approximately the current time as time passes.

According to a sixth aspect, in the method described in the fifth aspect, in the step of reading the assignment data and displaying thereof on the display unit, the computer displays thereof including a temporal axis of the period in the calendar chart, and

according to accepting a selection of one portion of the temporal axis from the user, in response to a period centering on a time indicated by the portion of the temporal axis selected, displays the calendar chart indicating a chronological state of use of each of the seats.

According to this configuration, an operational effect is achieved in which, in the step of reading the assignment data and displaying thereof on the display unit, the computer displays thereof including a temporal axis of the period in the calendar chart, and

according to accepting a selection of one portion of the temporal axis from the user, in response to a period centering on a time indicated by the portion of the temporal axis selected, displays the calendar chart indicating a chronological state of use of each of the seats.

As a result, the computer, while displaying the calendar chart on the display unit, accepts a selection of one portion of a displayed temporal axis by a pointing device or the like such as a mouse or the like from the user, and in response to a period centering on a time indicated by the portion of the temporal axis which has accepted a selection, displays a state of use of the seats as a calendar chart, thus informing the user of a state of use of a desired period of time.

The result is that it is possible for the user, with a pointing device or the like such as a mouse or the like, just by selecting one portion of the temporal axis, to confirm a state of use of seats of a period of time centering on a time indicated by the selected portion of the temporal axis.

By repeating this operation, it is possible for the user mentally to visualize and simulate a state of use of seats as time passes.

Therefore, it is possible for the user, in a case in which business is being carried out smoothly, to make a confirmation centered on the current state of use. Furthermore, in a case in which some kind of disturbance, such as sudden leave of absence of an employee, failure of equipment, or the like, occurs, it is possible for the user, by switching times displayed on a calendar chart one after another, when planning such measures as alternative settings of seats or assignment changes of employees, to refer to a visually intuitive and easy-to-understand display screen.

Moreover, after displaying a state of use of seats of a designated period of time as a result of the above-described operation, according to a passing of a prescribed time without accepting an operation from the user, it is acceptable for the computer to display a state of use of seats of a period of time centering on the current time again.

According to a seventh aspect, the method described in any one of the first to sixth aspects, further comprises steps of: accepting from the user a designating operation of a prescribed assignment rule to be considered when making assignments, and

storing the prescribed designated assignment rule in the memory according to accepting the designating operation, wherein

in the step of determining whether the seat after change accepted is usable, further determining whether the prescribed assignment rule stored correspond, which is reflected on the determination of whether the seat is usable.

According to this configuration, an operational effect is achieved in which the computer accepts from the user a designating operation of a prescribed assignment rule to be considered when making assignments, and

stores the prescribed designated assignment rule in the memory according to accepting the designating operation, wherein

in the step of determining whether the seat after change accepted is usable, further determines whether the prescribed assignment rule stored correspond, which is reflected on the determination of whether the seat is usable.

As a result, in a case of accepting a change operation of a seat or the like, the computer additionally confirms agreement with prescribed assignment rules, which is reflected on a determination of whether change is possible.

The result is that it is possible for the user to avoid making changes not matching the above-described assignment rules to a seat arrangement. For example, in a case in which there is an assignment rule of “assign new recruits next to experienced employees”, if there are no experienced employees next to a seat designated by a change operation of the user, it is possible to avoid that kind of change operation since the change would be determined to be impossible. Alternatively, in a case in which certain employees are in an enmity relationship, in a case in which there is an assignment rule of “segregating employees in an enmity relationship by three or more seats”, a similar determination would be possible. Furthermore, in a case in which there is a multitude of such assignment rules, it is possible for the user to obtain results of a determination taking into consideration all of the plurality of conditions.

According to an eighth aspect, the method described in the seventh aspect, wherein the memory further stores, as one of the prescribed assignment rules, shift pattern data indicating a period of work common to a plurality of the employees, comprises steps of:

accepting an operation instructing a change of the period of work by designating the shift pattern data from the user; and

changing and storing in the memory, based on the operation, periods of work of employees having the common designated shift pattern data.

According to this configuration, an operational effect is achieved in which the memory further stores, as one of the prescribed assignment rules, shift pattern data indicating a period of work common to a plurality of the employees, and

the computer accepts an operation instructing a change of the period of work by designating the shift pattern data from the user, and

changes and stores in the memory, based on the operation, periods of work of employees having the common designated shift pattern data.

As a result, it is possible for the computer, in a case of accepting a change operation for a shift pattern, even in a case in which a multitude of employees are included in the shift pattern, automatically to change periods of work of these employees collectively, and to store thereof in the memory unit.

The result is that it is possible for a user to reduce labor in changing a period of work of employees included in the shift pattern.

According to a ninth aspect, a computer assigns employees to seats,

the computer including a memory for storing assignment data configured to include at least data related to employees assigned and a period of use for each of the seats, wherein the computer comprises:

a unit of accepting an operation requesting display of the assignment data, accompanying designations of a seat and a period, from a user of the computer,

a unit of reading the assignment data from the memory and displaying thereof on a display unit, according to an accepting of the operation requesting display,

a unit of accepting a designating operation of a seat and an employee as targets of change, and of a seat after change, from the user,

a unit of referring to assignment data stored in the memory, and determining whether the seat after change accepted is usable,

a unit of changing the assignment data and storing thereof in the memory, in a case in which it is determined that the seat after change is usable, and

a unit of displaying the assignment data after change on the display unit.

According to this configuration, it is possible to anticipate the same effect as in the first aspect by using the computer.

In a tenth aspect, a program assigning employees to seats in a computer,

the computer including a memory for storing assignment data configured to include at least data related to employees assigned and a period of use for each of the seats, wherein the program executes steps of:

accepting an operation requesting display of the assignment data, accompanying designation of a seat and a period, from a user of the computer,

reading the assignment data from the memory and displaying thereof on a display unit, according to an accepting of the operation requesting display,

accepting a designating operation of a seat and an employee as targets of change, and of a seat after change, from the user,

referring to assignment data stored in the memory, and determining whether the seat after change accepted is usable,

changing the assignment data and storing thereof in the memory, in a case in which it is determined that the seat after change is usable, and

displaying the assignment data after change on the display unit.

According to this configuration, it is possible to anticipate the same effect as for the first aspect by installing and using the program on the computer.

### Effects of the Invention

According to the present invention, the computer displays on the display unit data relating to an employee and a period of use assigned to a seat included in assignment data stored in the memory, and by accepting an operation from the user, determines whether a change of a seat is possible, and in a case where it is possible, can display assignment data after change on the display unit. As a result, it is possible for the user to carry out suitable changes in seats in response to various disturbances that may occur up to the work date after drawing up an employee assignment plan, and to carry out suitable change management of assignments.

### BRIEF DESCRIPTION OF THE DRAWINGS

FIG. 1 is a diagram illustrating a functional configuration of a computer 1 relating to a preferred embodiment of the present invention;

FIG. 2 is a flowchart illustrating a flow of assignment data change processing;

FIG. 3 is a diagram illustrating assignment data;

FIG. 4 is a diagram illustrating status data;

FIG. 5 is a diagram illustrating an example of a display screen;

FIG. 6 is a diagram illustrating an example of a display screen;

FIG. 7 is a diagram illustrating an example of a display screen;

FIG. 8 is a diagram illustrating a shift pattern;

FIG. 9 is a diagram illustrating assignment rules; and

FIG. 10 is a flowchart illustrating a flow of shift pattern change processing.

### PREFERRED MODE FOR CARRYING OUT THE INVENTION

An embodiment of the present invention is explained below with reference to the drawings. Moreover, this is only an example, and the technical scope of the present invention is not to be limited thereto.

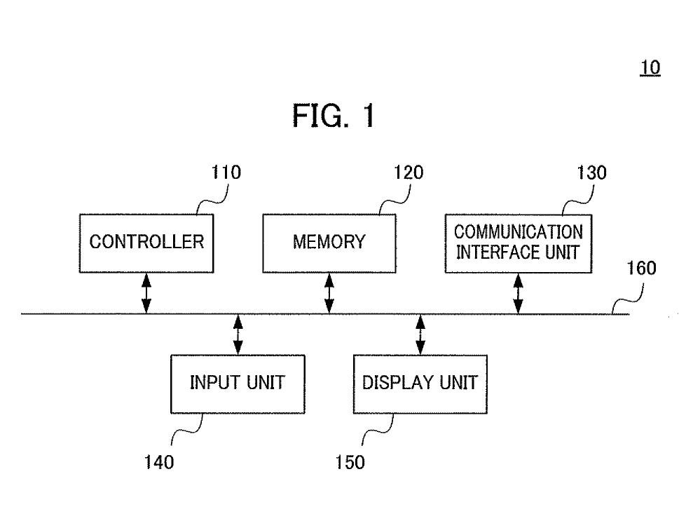

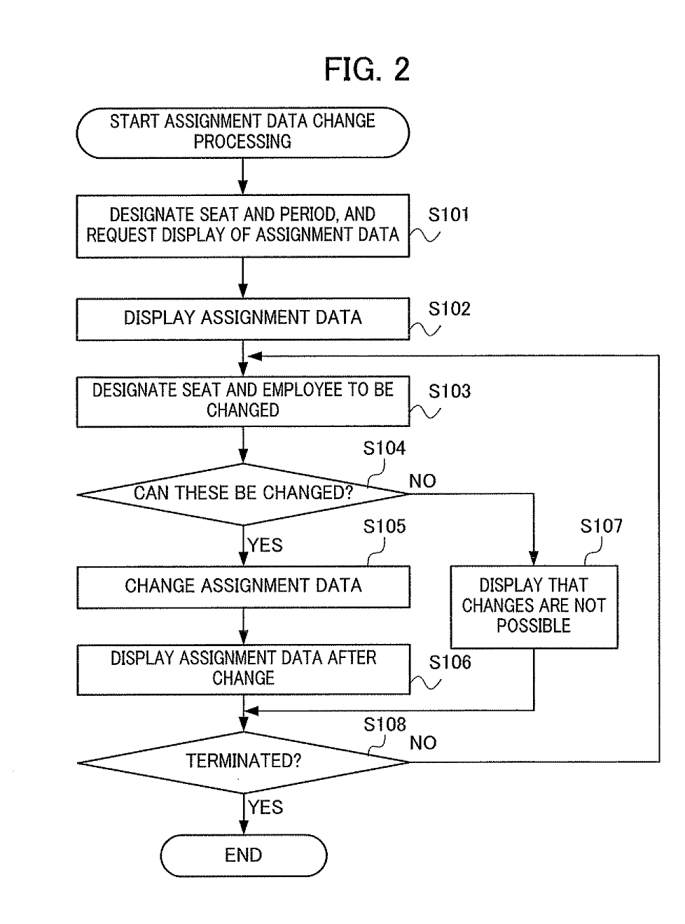

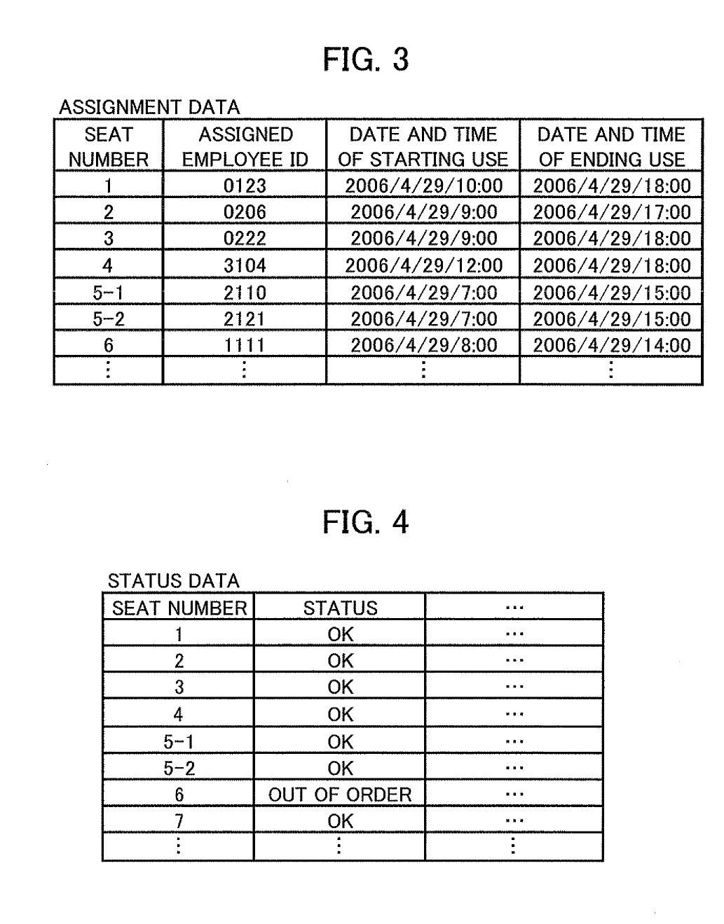

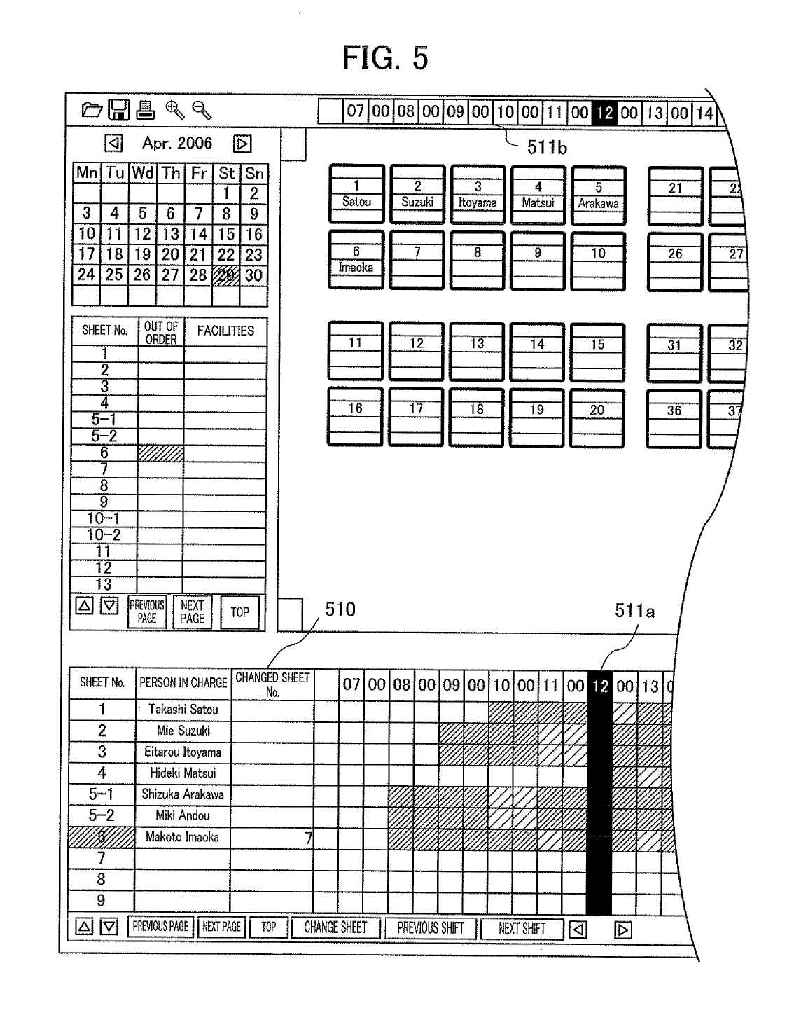

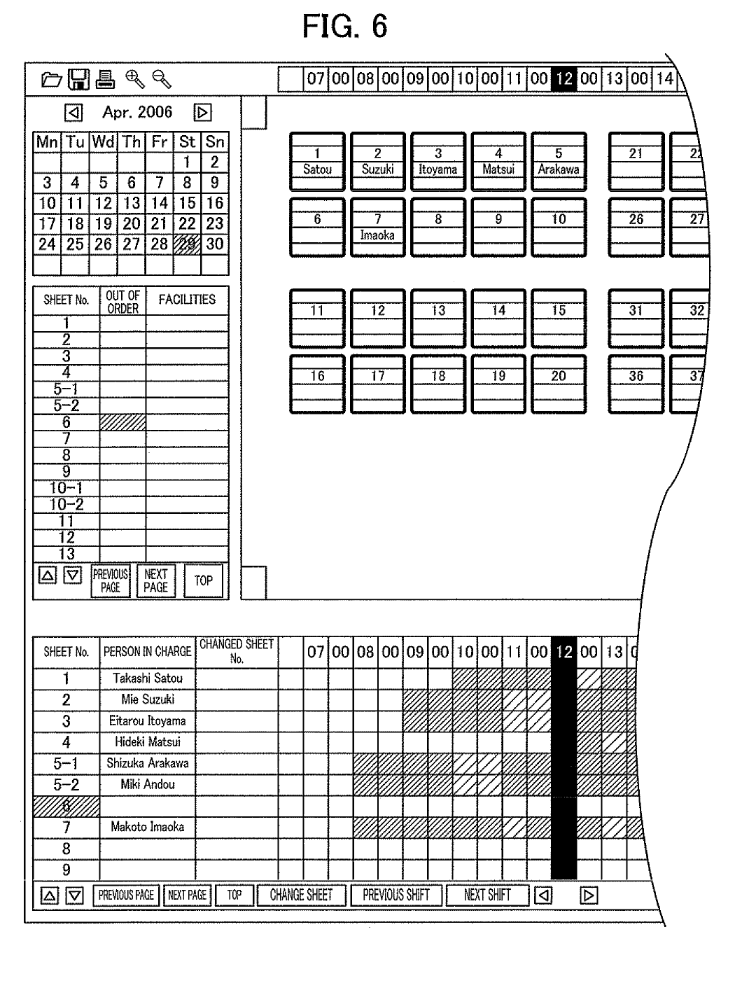

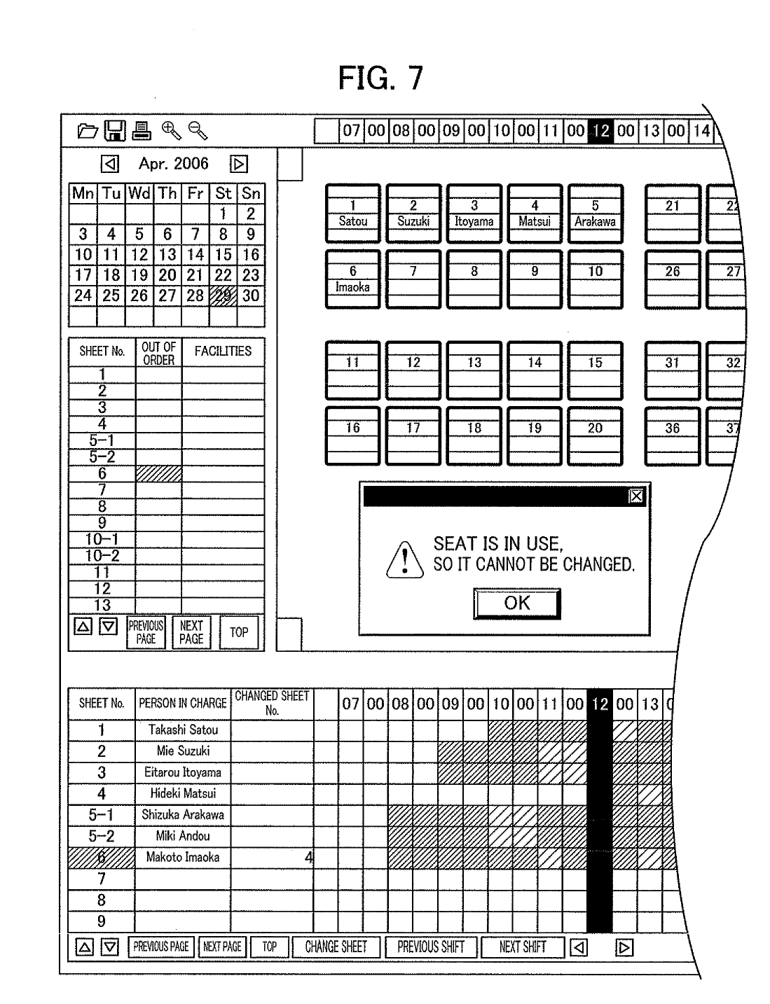

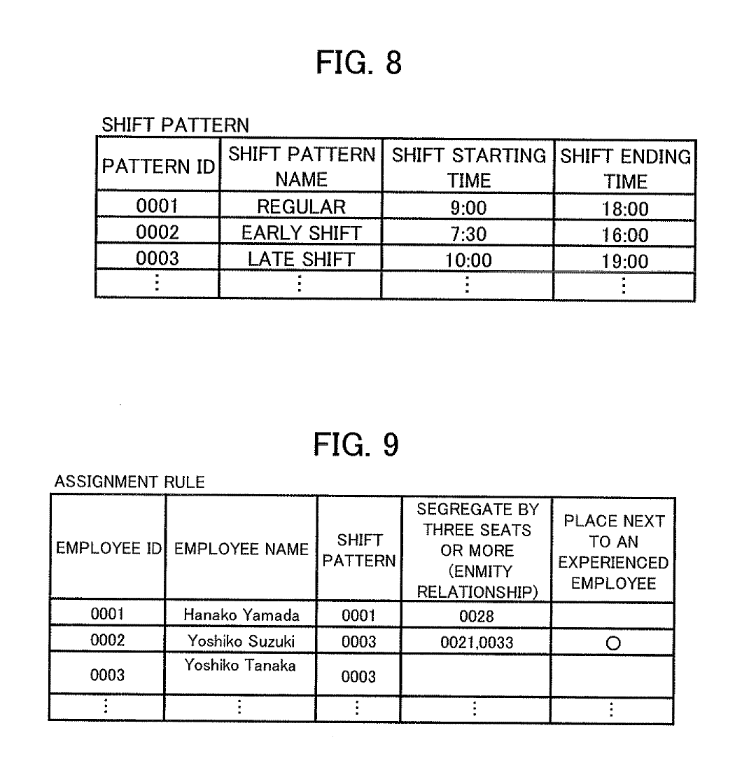

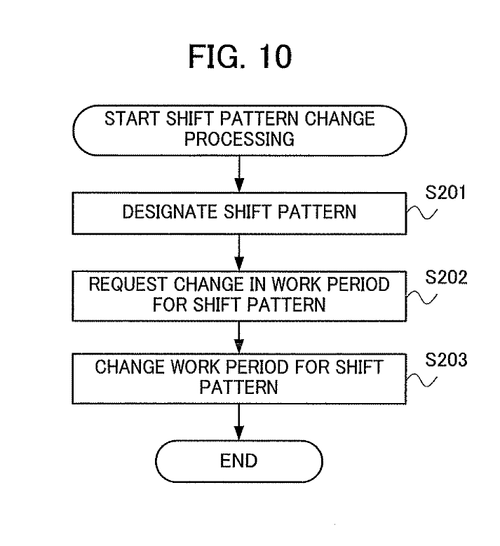

FIG. 1 is a diagram illustrating a functional configuration of a computer 1 relating to a preferred embodiment of the present invention. FIG. 2 is a flowchart illustrating a flow of assignment data change processing. FIG. 3 is a diagram illustrating assignment data. FIG. 4 is a diagram illustrating status data. FIG. 5 is a diagram illustrating an example of a display screen. FIG. 6 is a diagram illustrating an example of a display screen. FIG. 7 is a diagram illustrating an example of a display screen. FIG. 8 is a diagram illustrating a shift pattern. FIG. 9 is a diagram illustrating assignment rules. FIG. 10 is a flowchart illustrating a flow of shift pattern change processing.

### Functional Configuration of the Computer

As illustrated in FIG. 1, a computer 1 relating to a preferred embodiment of the present invention is composed of a controller 110, a memory 120, a communication interface unit 130, an input unit 140, and a display unit 150 connected together through a bus 160.

The controller 110 is an information calculation processing device carrying out calculation and processing of information, and may be a CPU (Central Processing Unit). In addition, the controller 110 carries out overall control of the computer 1, and by the controller 110 suitably reading and executing various programs stored in the memory 120, the above-mentioned hardware functions collaboratively in realizing various functions relating to the present invention.

Here, the display unit 150 is a device to display a screen to a user for accepting input of data, or for displaying calculation processing results of the computer 1 on a screen, and includes display devices such as a cathode-ray tube (CRT), a liquid-crystal display (LCD), and the like. In addition, as described above, the display device itself may be configured to include touch panel functionality, and may be realized as a single unit by incorporating a portion of functionality of the input unit 140 described below.

Here, the input unit 140 accepts input by a user, and may include a keyboard, a pointing device and the like such as a mouse, and the like.

Here, a communication interface unit 130 is a network adapter for the purpose of enabling a computer 1 to connect through a special network or public network to a terminal. The communication interface unit 130 may include a modem, a cable modem, and an Ethernet (registered trademark) adapter.

Here, the memory unit 120 may include a local memory for use in executing a program in combination with the controller 110, high-capacity bulk memory, and cache memory for use in efficient search of the bulk memory. As a computer-readable medium for realizing the memory unit 120, it is acceptable to include a medium that can be realized electrically, magnetically, optically, or electromagnetically. More specifically, semiconductor storage devices, magnetic tapes, flexible discs, random access memory (RAM), read-only memory (ROM), and optical discs, including CD-ROMs and CD-R/Ws and DVDs, are included.

Moreover, as described above, the computer 1 related to the present invention, although having been described, may be realized not only with a general-purpose so-called “personal computer”, but with special hardware for which the principles of the present invention may be applied.

### Assignment Data Change Processing

As illustrated in FIG. 2, a computer 1 relating to a preferred embodiment of the present invention carries out assignment data change processing.

First, a controller 110 of the computer 1 accepts through an input unit 140 an operation requesting display of the assignment data accompanying a designation of a seat and a period from a user of the computer 1 (Step S101). More specifically, for example, the controller 110, in a case of displaying on the display unit 150 a screen such as that indicated in FIG. 5, accepts operations from the user of designating “Apr. 24, 2006” as a period, “seat numbers 1-100” as seats, and a request for displaying assignment data.

A specific example of assignment data is illustrated in FIG. 3. In the example of FIG. 3, the employee of Employee ID “0123” has been assigned to seat number “1” from “Apr. 29, 2006, at 10:00” to “Apr. 29, 2006, at 18:00”. “The assignment data, in this manner, is composed to include information on the seat, employee assigned, date and time of starting use, and date and time of ending use. Therefore, by referring to assignment data, it is possible to ascertain from when and to when an employee have been assigned, and to which seat.

Next, the controller 110 displays assignment data according to a designated seat and period (Step S102). More specifically, for example, a screen such as that indicated in FIG. 5 is displayed. In the example of FIG. 5, it can be seen that at the time “12:00” of April 29, the employee “Takashi Satou” has been assigned to seat number “1”. In addition, in the example of FIG. 5, the controller 110 displays a usage status of seats in a time period centered to be five hours before and after the time of “12:00” on April 29, as a chronological calendar chart 510. Furthermore, the controller 110 additionally carries out a displaying of temporal axes 511a and 511b indicating a displayed period of time of calendar chart 510. Additionally, the controller 110, through an operation of a pointing device or the like such as a mouse or the like as the input unit 140, by accepting a selection of one portion of the temporal axes 511a or 511b (for example, the portion “11” indicating 11:00) from a user, redisplays a usage status of seats in a time period centered to be five hours before and after the time of “11:00”. In addition, it is possible for the controller 110, in a case of the user not carrying out an operation for a prescribed amount of time or longer, automatically to switch to a display of the calendar chart 510 of a period of time centered on the current time.

Here, in FIG. 5, since an “out of order” column for seat number “6” is displayed highlighted, it is possible for the user to ascertain that, currently, equipment of seat number “6” is out of order.

This display is status data representing the status of each seat number indicated in FIG. 4, as displayed by the controller 110 on the display unit 150. In FIG. 4, “out of order” is stored in the “status” column of seat number “6”.

It is possible for the user, after creation of an assignment plan, in a case of a failure of equipment occurring as one disturbance that may occur by a work date, for example, to highlight-display by clicking the “out of order” column of the sheet number with a pointing device or the like such as a mouse or the like in a chart representing status data displayed as indicated in FIG. 5. It is possible for the controller 110 to accept through a pointing device or the like such as a mouse or the like, as the input unit 140, this kind of operation, and to change and update the status data indicated in FIG. 4 from “OK” to “out of order”, and afterwards, in a case in which the user displays a screen such as that of FIG. 5, the “out of order” column can be highlight-displayed, thereby informing the user of that.

In addition, the user has newly assigned employees (communicators) to seats not only in a case of an occurrence of failure of equipment as described above, but even after drawing up an employee (communicator) assignment plan in a case in which an unexpected increase in quantity of calls occurs as one disturbance.

Next, the controller 110 accepts a designation of seats and employees to be changed from a user (Step S103). More specifically, for example, in the example of FIG. 5, the controller 110 accepts an operation of changing a seat number for an employee, “Makoto Imaoka”, assigned to seat number “6”, which is out of order, to seat number “7”. In this case, for example, the controller 110 highlight-displays a position of “6” in a column, “Seat Number”, through a click operation of a pointing device or the like such as a mouse or the like as the input unit 140, and accepts an input of “7” through an input operation of a keyboard or the like in the location of a column of “Changed Seat Number”.

Next, the controller 110 refers to assignment data, and determines whether a designated change is possible (Step S104). More specifically, for example, in the example of FIG. 5, whether the new assignment is possible for an employee for the designated seat number “7” after change is determined. In this case, for seat number “7”, since other employees are not assigned for the time period (8:00 to 14:00 on Apr. 29, 2006 (see FIG. 3)) for which employee “Makoto Imaoka” is being assigned, the controller 110 determines that the change is possible. In a case in which it is determined that the change is possible, the controller 110 transitions processing to Step S105, and in a case in which it is determined that the change is not possible, processing is transitioned to Step S107.

In a case in which it was determined that the change is possible in Step S104, the controller 110 changes the assignment data as designated (Step S105). More specifically, in the example of FIG. 5, the employee “Makoto Imaoka”, who is assigned to seat number “6” “from 8:00 to 14:00 on Apr. 29, 2006 (see FIG. 3)”, is reassigned to seat number “7”. An example of a screen displayed on the display unit 150 after the change is indicated in FIG. 6 (Step S106).

Here, in a case in which it was determined that the change was not possible in Step S104, the controller 110 displays that the change is not possible on the display unit 150 (Step S107). More specifically, for example, as illustrated in FIG. 7, in a case in which a change is attempted for the employee “Makoto Imaoka”, assigned to seat number “6” “from 8:00 to 14:00 on Apr. 29, 2006” (see FIG. 3), to seat number “4”, the controller 110 accepts the change operation from the user through the input unit 140.

As illustrated in FIG. 3, since “Hideki Matsui (see FIG. 7)” of employee ID “3104” has been assigned to seat number “4” “from 12:00 on Apr. 29, 2006, to 18:00 on Apr. 29, 2006”, and since two employees would be assigned to one seat in the time period of “from 12:00 on Apr. 29, 2006, to 14:00 on Apr. 29, 2006”, the above-described change cannot be realized.

In this case, as illustrated in FIG. 7, a message that “Seat is in use, so it cannot be changed” is displayed, and it is possible for the user to ascertain this. In this way, according to a change operation of a user, the controller 110 displays a message of this type on the display unit 150 each time in a case in which the change is not possible, and since the change is not carried out, simply by the user just repeatedly carrying out a change operation, only changeable operations are achieved. Therefore, it is possible for the user to reduce labor of checking at a time of a change operation, while also avoiding a risk of carrying out an unfeasible change by operational error or the like.

Here, it is possible for the controller 110 to determine whether change is possible according to not just whether a seat after change is available, as in the example described above, but also various assignment rules for the purpose of employee placement. For example, in the example illustrated in FIG. 9, “Hanako Yamada” of employee ID “0001” is shift pattern “0001”, and it is stored to “segregate by three or more seats (enmity relationship)” from the employee of employee ID “0028”. Thus, for example, at a time of changing the seat of this “Hanako Yamada”, it is possible for the controller 110 to determine, in accordance with such assignment rules as “segregate by three or more seats” from the employee of employee ID “0028” with whom this employee is in an enmity relationship and the like, whether the above-described change is possible.

Furthermore, as illustrated in FIG. 8, since the shift pattern “0001” of “Hanako Yamada” is indicated to be a “regular” shift pattern, it is possible for the controller 110, in a case of, for example, accepting an operation from a user changing a shift pattern to an “early shift”, to determine that the change is not possible.

Furthermore, in a case of there being an assignment rule of “assign a new employee next to an experienced employee”, in the assignment rule illustrated in FIG. 9, an “o” is stored in the column for “place next to an experienced employee” for “Yoshiko Suzuki” of employee ID “0002”. In this case, the controller 110, based on requests from a user, in a case of assigning “Yoshiko Suzuki”, considers whether this condition is matched at a time of determining whether the above-described change is possible.

In this manner, the controller 110 repeatedly implements the above-described series of assignment data change processes until accepting a termination request (Step S108) from the user.

### Shift Pattern Change Processing

As illustrated in FIG. 10, the computer 1 related to a preferred embodiment of the present invention carries out shift pattern change processing.

First, the controller 110 of the computer 1 accepts a designation of a shift pattern from a user of the computer 1 (Step S201). More specifically, for example, through a click operation of a pointing device or the like of a mouse or the like as the input unit 140, a designation of a shift pattern of “early shift” of pattern ID “0002” is accepted, in the shift pattern illustrated in FIG. 8, which is displayed in the display unit 150.

Next, the controller 110 accepts a change request of a period of work of the designated shift pattern (Step 5202). More specifically, for example, the controller 110, through an input operation of a keyboard or the like as the input unit 140, accepts a request of changing a starting time from “7:30” to “8:00”.

Next, the controller 110, according to the accepted change request, changes a period of work of the shift pattern (Step S203). More specifically, for example, the controller 110, in the above-described example, changes the starting time from “7:30” to “8:00”.

In this way, it is possible for the controller 110, based on a request operation of a user, to carry out a change of a shift pattern. As a result, it is possible collectively to change periods of work of all employees for whom the shift pattern has been applied. For example, in the above-described example, it is possible collectively to change the starting time for employees for whom the shift pattern “early shift” has been applied from “7:30” to “8:00”. As a result, it is not necessary for the user to change periods of work of the employees individually, and it is possible to reduce labor in change operations.

As above, an embodiment of the present invention has been described; however, the present invention is not to be limited to the above-described embodiment. In addition, the effect described in the embodiment of the present invention has only been recited as the most preferable effect generated by the present invention, and the effect of the present invention is not to be limited to that described in the embodiment of the present invention.

1. A method of a computer assigning employees to seats,
the computer including a memory for storing assignment data configured to include at least data related to employees assigned and a period of use for each of the seats, wherein the method comprises steps of:
accepting an operation requesting display of the assignment data, accompanying designations of a seat and a period, from a user of the computer;
reading the assignment data from the memory and displaying thereof on a display unit, according to an accepting of the operation requesting display;
accepting a designating operation of a seat and an employee as targets of change, and of a seat after change, from the user;
referring to assignment data stored in the memory, and determining whether the seat after change accepted is usable;
changing the assignment data and storing thereof in the memory, in a case in which it is determined that the seat after change is usable; and
displaying the assignment data after change on the display unit.

2. The method described in claim 1, further comprising a step of displaying on the display unit that the change is not possible, without carrying out change of the assignment data, in a case of determining that the seat after change is not usable.

3. The method described in claim 1, wherein:
the memory further stores data representing whether equipment at the seat is out of order, further comprising steps of:
accepting a designating operation of the seat for which a failure has occurred from the user in a case in which failure of equipment at the seat has occurred;
storing in the memory status data indicating that equipment at the seat designated is out of order, according to an accepting of the designating operation; and
displaying on the display unit that equipment at the seat is out of order, based on status data stored in the memory.

4. The method described in claim 1, wherein:
in the step of reading the assignment data and displaying thereof on the display unit, the computer, in response to the seat designated and period, displays a calendar chart indicating a chronological state of use of each of the seats, and
in the calendar chart, displays a period for which the seat is in use distinctly from a period being available.

5. The method described in claim 1, wherein:
in the step of reading the assignment data and displaying thereof on the display unit, the computer, in response to a period that at least includes a current time, displays a calendar chart indicating a chronological state of use of each of the seats designated.

6. The method described in claim 5, wherein:
in the step of reading the assignment and displaying thereof on the display unit, the computer displays thereof including a temporal axis of the period in the calendar chart, and
according to accepting a selection of one portion of the temporal axis from the user, in response to a period centering on a time indicated by the portion of the temporal axis selected, displays the calendar chart indicating a chronological state of use of each of the seats.

7. The method described in claim 1, further comprising steps of:
accepting from the user a designating operation of a prescribed assignment rule to be considered when making assignments; and
storing the prescribed designated assignment rule in the memory according to accepting the designating operation, wherein
in the step of determining whether the seat after change accepted is usable, further determining whether the prescribed assignment rule stored correspond, which is reflected on the determination of whether the seat is usable.

8. The method described in claim 7, wherein the memory further stores, as one of the prescribed assignment rules, shift pattern data indicating a period of work common to a plurality of the employees, comprising steps of:
accepting an operation instructing a change of the period of work by designating the shift pattern data from the user; and
changing and storing in the memory, based on the operation, periods of work of employees having the common designated shift pattern data.

9. A computer assigning employees to seats,
the computer including a memory for storing assignment data configured to include at least data related to employees assigned and a period of use for each of the seats, wherein the computer comprises:
a unit of accepting an operation requesting display of the assignment data, accompanying designations of a seat and a period, from a user of the computer;
a unit of reading the assignment data from the memory and displaying thereof on a display unit, according to an accepting of the operation requesting display;
a unit of accepting a designating operation of a seat and an employee as targets of change, and of a seat after change, from the user;
a unit of referring to assignment data stored in the memory, and determining whether the seat after change accepted is usable;
a unit of changing the assignment data and storing thereof in the memory, in a case in which it is determined that the seat after change is usable; and
a unit of displaying the assignment data after change on the display unit.

10. A program assigning employees to seats for a computer,
the computer including a memory for storing assignment data configured to include at least data related to employees assigned and a period of use for each of the seats, wherein the program comprises steps of:
accepting an operation requesting display of the assignment data, accompanying designation of a seat and a period, from a user of the computer;
reading the assignment data from the memory and displaying thereof on a display unit, according to an accepting of the operation requesting display;
accepting a designating operation of a seat and an employee as targets of change, and of a seat after change, from the user;
referring to assignment data stored in the memory, and determining whether the seat after change accepted is usable;
changing the assignment data and storing thereof in the memory, in a case in which it is determined that the seat after change is usable; and
displaying the assignment data after change on the display unit.
